(19) United States
(12) Patent Application Publication
(10) Pub. No.: US 2025/0010908 A1
(43) Pub. Date: Jan. 9, 2025

(54) STEER-BY-WIRE STEERING COLUMN WITH LOW TRANSLATING ENERGY ABSORPTION MASS

(71) Applicant: Steering Solutions IP Holding Corporation, Saginaw, MI (US)

(72) Inventors: Michael P. Anspaugh, Bay City, MI (US); Randy W. Jones, North Branch, MI (US); John F. Schulz, Hemlock, MI (US); Jacob A. Caverly, Freeland, MI (US); Todd M. King, Saginaw, MI (US); Sergio R. Molinar, Freeland, MI (US)

(21) Appl. No.: 18/763,567

(22) Filed: Jul. 3, 2024

Related U.S. Application Data
(60) Provisional application No. 63/525,071, filed on Jul. 5, 2023.

(51) Int. Cl. B62D 5/00; B62D 1/187

(52) U.S. Cl. CPC B62D 5/006; B62D 1/187

(57) ABSTRACT

A steer-by-wire steering column includes an upper jacket extending in a longitudinal direction. The steering column also includes a lower jacket extending in the longitudinal direction, the upper jacket in telescoping engagement with the lower jacket. The steering column further includes a single steering shaft extending in the longitudinal direction and housed at least partially within the upper jacket and the lower jacket.

### CROSS-REFERENCE TO RELATED APPLICATION

This application claims the benefits of priority to U.S. Provisional Patent Application Ser. No. 63/525,071, filed Jul. 5, 2023, the disclosure of which is incorporated by reference herein in its entirety.

### TECHNICAL FIELD

This disclosure relates to vehicle steering systems and, more particularly, to a steer-by-wire steering column with a low translating energy absorption mass.

### BACKGROUND

A vehicle, such as a car, truck, sport utility vehicle, crossover, mini-van, marine craft, aircraft, all-terrain vehicle, recreational vehicle, or other suitable vehicles, typically include a steering system having a steering column. For many years, steering columns included one or more jacket housings which contain a steering shaft assembly that is physically connected to a rack or other device that manipulated the road wheels. Advancements in electric technology have led to developments that eliminate the continuous physical connection between the steering input device and the road wheels. One such steering system is referred to as a steer-by-wire steering system. Another electric system is referred to as electric powered steering (EPS), with the power provided at the column or the rack, for example.

As with any system, it is typically advantageous to reduce the number of components and complexity of the system. In addition to the number of components required by prior steering columns for systems of the steer-by-wire type, the hand wheel actuator which provides resistance, feedback and assistance to a steering shaft is often assembled to the steering column at an angle or even perpendicular to the longitudinal axis of the steering column, thereby requiring additional space and complicating overall packaging efforts. Prior steering systems require more than one steering shaft portion, such as an upper and lower steering shaft. Such designs result in extended packaging length, higher cost due to added complexity and more components, and make achieving NVH requirements challenging.

### SUMMARY OF THE DISCLOSURE

According to one aspect of the disclosure, a steer-by-wire steering column includes an upper jacket extending in a longitudinal direction. The steering column also includes a lower jacket extending in the longitudinal direction, the upper jacket in telescoping engagement with the lower jacket. The steering column further includes a single steering shaft extending in the longitudinal direction and housed at least partially within the upper jacket and the lower jacket.

According to another aspect of the disclosure, a steer-by-wire steering column includes an upper jacket extending in a longitudinal direction. The steering column also includes a lower jacket extending in the longitudinal direction, the upper jacket in telescoping engagement with the lower jacket, wherein the lower jacket comprises a first portion and a second portion. The steering column further includes a single steering shaft extending in the longitudinal direction and housed at least partially within the upper jacket and the lower jacket. The steering column yet further includes a steer-by-wire electric actuator at least partially disposed within the lower jacket and surrounding the single steering shaft to provide resistance to the single steering shaft, wherein the first portion houses at least a portion of the upper jacket and the second portion houses at least a portion of the electric actuator. The first portion of the lower jacket defines a pair of slots for receiving an adjustment post of a manual adjustment assembly therethrough. The second portion of the lower jacket defines a pair of slots for receiving components extending from a pivot post that the lower jacket moves relative to.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 schematically illustrates a vehicle steer-by-wire steering system;

FIG. 2 is a perspective view of a portion of the steer-by-wire steering column;

FIG. 3 is a side, elevation view of a portion of the steer-by-wire steering column;

FIG. 4 is a perspective, cross-sectional view of a portion of the steer-by-wire steering column;

FIG. 5 is a side, elevation, cross-sectional view of a portion of the steer-by-wire steering column;

FIG. 6 is a perspective view of a portion of the steer-by-wire steering column; and

FIG. 7 is a side, elevation view of a portion of the steer-by-wire steering column according to another aspect of the disclosure.

### DETAILED DESCRIPTION

The following discussion is directed to various embodiments of the disclosure. The embodiments disclosed herein should not be interpreted, or otherwise used, as limiting the scope of the disclosure, including the claims. In addition, one skilled in the art will understand that the following description has broad application, and the discussion of any embodiment is meant only to be illustrative of that embodiment, and not intended to intimate that the scope of the disclosure, including the claims, is limited to that embodiment.

The embodiments disclosed herein may benefit various types of steering systems in a vehicle, such as a car, truck, sport utility vehicle, crossover, mini-van, marine craft, aircraft, all-terrain vehicle, recreational vehicle, or other suitable vehicle. In particular, the embodiments relate to a steer-by-wire steering column with manual adjustment capability, where the steering column advantageously eliminates steering column parts when compared to a traditional steering column, which typically requires two or more steering shaft components.

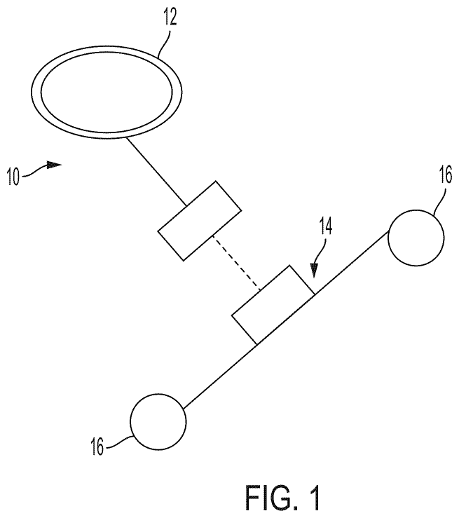

Referring to FIG. 1, the steering column assembly is generally referenced with numeral 10. The steering column assembly includes a steering wheel 12, wherein a driver may provide a steering input by turning the steering wheel 12. The steering column assembly 10 is a steer-by-wire type of steering system. Therefore, the steering column assembly 10 does not include a continuous mechanical connection between the steering wheel 12 and an output gear and rack 14 which causes physical adjustment of road wheels 16 for steering maneuvers. Even in prior steer-by-wire systems, multiple steering shafts have been required to operatively couple the steering wheel 12 to another component, such as an actuator or the like. However, the embodiments disclosed herein reduce the number of primary components required by the steering column assembly 10.

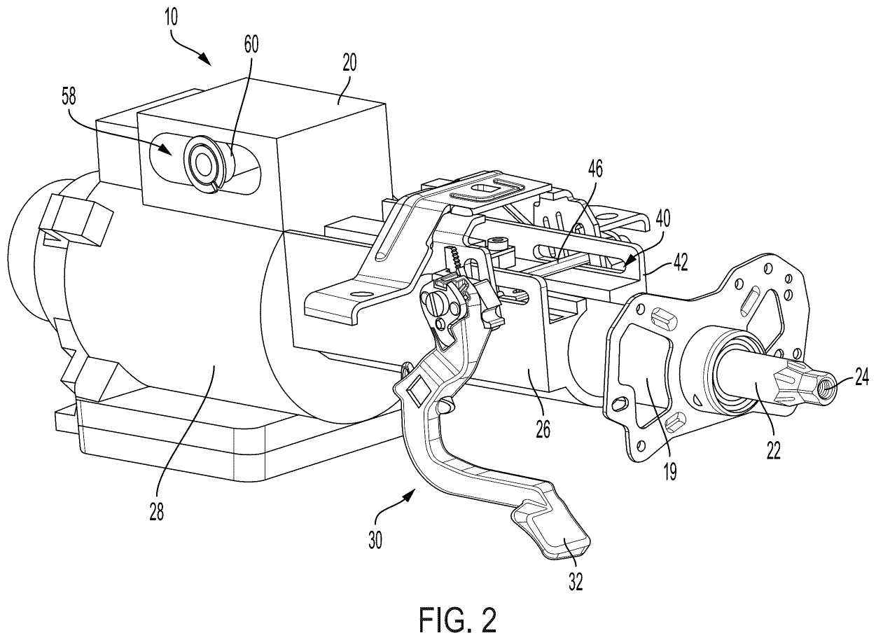

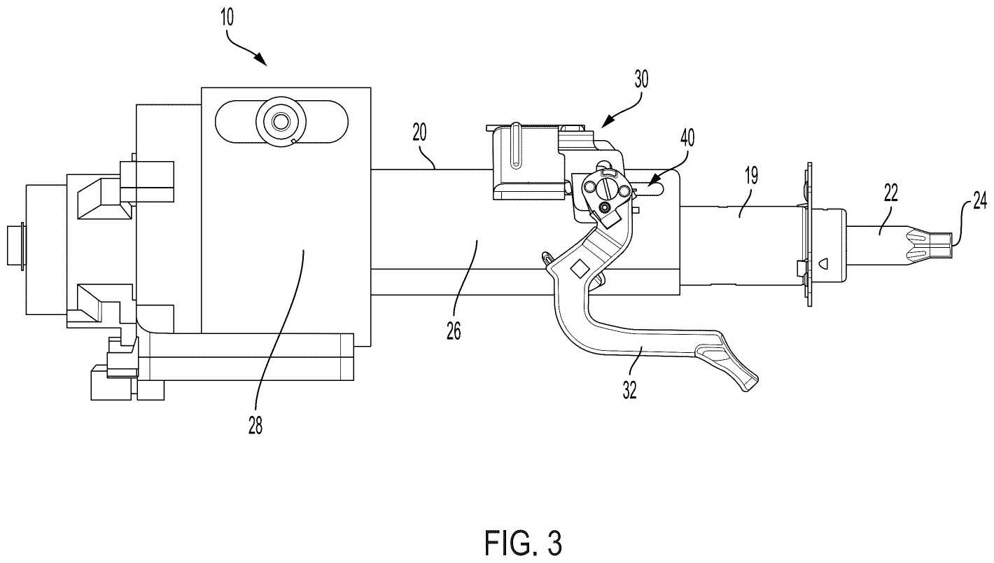

Referring now to FIGS. 2 and 3, the steering column assembly 10 is shown in more detail. The steering column assembly 10 includes an upper jacket 19 operatively coupled to a lower jacket 20 in a manner which allows the upper jacket 19 to telescope within the lower jacket 20 for axial adjustment thereof. The upper jacket 19 and the lower jacket 20 collectively house at least a portion of a single steering shaft 22. It is to be appreciated that the overall steering shaft assembly is limited to a single steering shaft and is not an assembled plurality of segments forming the steering shaft assembly. The single steering shaft 22 has an end 24 extending out of the upper jacket 19 in a generally rearward direction of the vehicle. The end 24 protruding out of the upper jacket 19 is configured to have a steering input device-such as a steering wheel-operatively coupled thereto.

The 10 also includes a manual adjustment assembly 30 which provides a user the ability to manually adjust an axial and/or rake position of the steer-by-wire steering column assembly 10. The term “axial” movement refers to movement of the upper jacket 19 and/or lower jacket 20 in a direction substantially parallel to a longitudinal axis A of the steer-by-wire steering column assembly 10. The term “rake” movement refers to movement of at least the upper jacket 19 in a substantially upward and downward direction, relative to the longitudinal axis A of the steer-by-wire steering column assembly 10. The manual adjustment assembly 30 includes an adjustment lever 32. Upon rotation of the adjustment lever 32, one or more cams 34 and/or other components move to an unlocked position which allows the upper jacket 19 and/or the lower jacket 20 to be manually adjusted.

The lower jacket 20 includes a first portion 26 and a second portion 28. The first portion 26 houses the upper jacket 19 in the manner described above. The second portion 28 is forward (in vehicle direction) of the first portion 26 and houses components associated with an actuator mechanism (e.g., motor), as described herein, which may also be referred to as a handwheel actuator. In the illustrated embodiment, the second portion 28 has a larger radius compared to the first portion 26.

The lower jacket 20 defines a first pair of slots 40 extending generally in a longitudinal direction of the steer-by-wire steering column assembly 10. The first pair of slots 40 may be defined within a pair of rails 42 protruding from the first portion 26 of the lower jacket 20, as illustrated. The pair of slots 40 allow an adjustment post 46 to extend through each of the slots 40 and connect to components of the manual adjustment assembly 30. During axial movement of the lower jacket 20, the adjustment post 46 slides within the slots 40 between a full axial “out” position and a full axial “in” position. The full axial out position corresponds to a rearmost position in a vehicle direction (i.e., closest position to operator). The full axial in position corresponds to a most forward position in a vehicle direction (i.e., farthest position from operator).

The second portion of the lower jacket 20 defines a second pair of slots 58. The second pair of slots 58 allow for operative coupling between the lower jacket 20 and a pivot post 60, such as a mounting bracket, for example. Components extending from the pivot post 60 extend through each of the slots 58. As with the adjustment post 46 in the first slots 40 of the first portion 26 of the lower jacket 20, the components of the pivot post 60 slide within the slots 58 of the second portion 28 of the lower jacket 20 between a full axial out position and a full axial in position during axial movement of the steer-by-wire steering column assembly. As shown, the full axial in position leaves room between the elements (i.e., components and adjustment post) disposed within the slots 40, 58 and respective ends of the slots 70, 72. In other words, the full axial out position of the adjustment post 46 is located at—or proximate to—a first end of the first pair of slots 40 and the full axial in position of the adjustment post 46 is located spaced from a second end of the first pair of slots 40. Similarly, the full axial out position of the at least one component within the second pair of slots 58 is located at—or proximate to—a first end of the second pair of slots 50 and the full axial in position of the at least one component is located spaced from a second end of the second pair of slots 50.

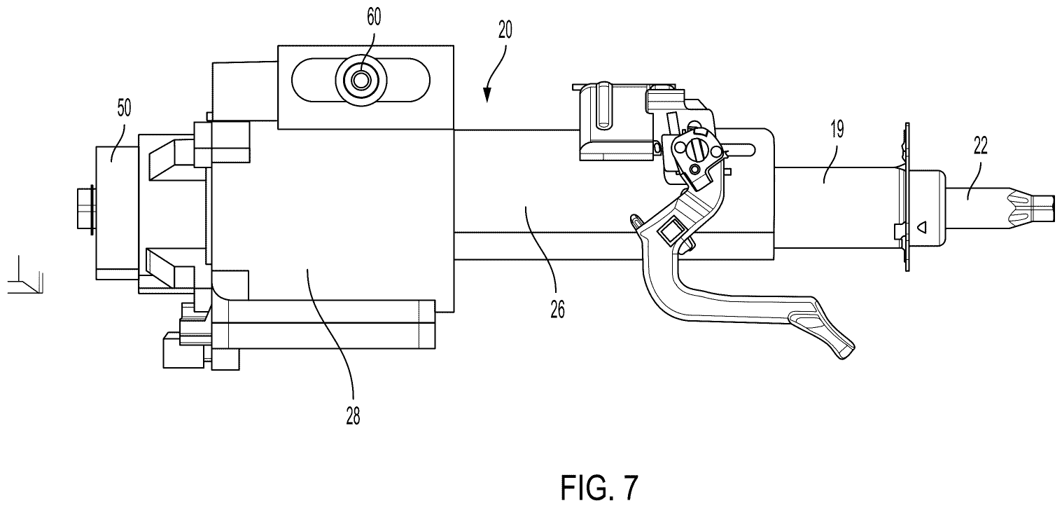

The above-described assembly provides space for the steer-by-wire steering column assembly 10 to go through an energy absorption stroke range. The energy absorption stroke range allows energy absorption during an impact event. The lower jacket 20 may translate axially during telescope movement of the upper jacket 19, but is stationary during energy absorption stroke. In such an embodiment, teeth in the first portion 26 of the lower jacket 20 secure the position of the lower jacket 20 during an energy absorption event (e.g., collision). In this embodiment, the lower jacket 20 moves axially during telescope adjustment of the steering column. Alternatively, in other embodiments, the lower jacket 20 is stationary during telescope movement and energy absorption stroke, as shown in FIG. 7. In this embodiment, a fastening screw between the energy absorption strap 102 and the lower jacket 20 is removed, the pivotable member 26 is shifted to a center position, and the absorption strap 102 has the plurality of teeth 104 added to a strap leg of the energy absorption strap 102.

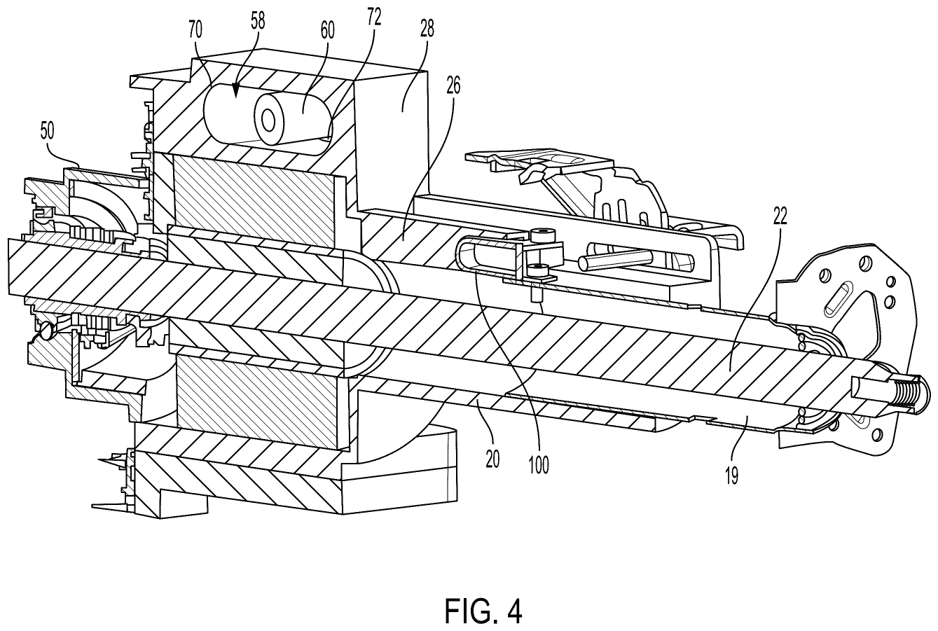

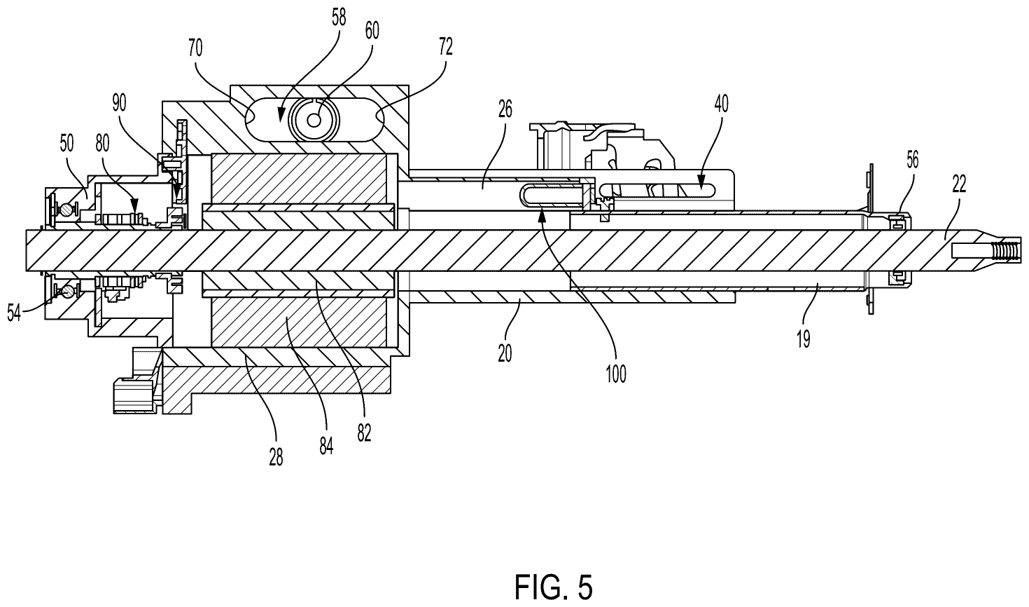

Referring now to FIGS. 4 and 5, with continued reference to FIGS. 2 and 3, the steer-by-wire steering column assembly 10 also includes a housing end structure 50 which is operatively coupled to the lower jacket 20. The housing end structure 50 is attached to an open end of the second portion 28 of the lower jacket 20 to close the lower jacket 20 and to provide a location to mount a lower bearing 54. In some embodiments, the lower bearing 54 is pressed into the housing end structure 50. The single steering shaft 22 is held by the lower bearing 54 and an upper bearing 56. In the illustrated perspective, the lower bearing 54 is on the left side of the single steering shaft 22 and the upper bearing 56 is on the right side of the single steering shaft 22. In some embodiments, the lower bearing 54 may be located within the lower jacket 20. Regardless of the precise position of the bearings 54, 56, retaining the single steering shaft 22 by two bearings provides a stable structure for creating a stiff steering column design assembly.

Referring again to FIGS. 4 and 5, a partial cross-sectional view illustrating an interior cavity 80 of the lower jacket 20. One or more magnets forming a rotor structure assembly 82 are mounted to a radially outer surface of the single steering shaft 22. Copper windings of a motor stator 84 are mounted to an interior wall 86 of the lower jacket 20 and do not rotate. The motor stator 84 at least partially surrounds the rotor structure assembly 82. The magnets of the rotor assembly 82 rotate with the single steering shaft 22. The overall steer-by-wire electric device (e.g., motor plus additional components) may be referred to as an “emulator” or the handwheel actuator, as described above. The emulator resists turning the single steering shaft 22 to provide steering feedback to the driver and assists with steering inputs to adjust effort required by the driver. The emulator is mounted in a manner in which the emulator directly surrounds the single steering shaft 22 to eliminate the need for a gear box by utilizing a direct drive system. The assembly also includes one or more rotation position sensors 90 to detect the angular rotational position of the single steering shaft 22. It is to be appreciated that the rotation position sensor(s) 90 could be located as shown in FIG. 5 or may be shifted to other positions along the steering shaft axis. Additionally, one or more travel stop limiters 92 to define rotational travel limits for movement of the single steering shaft 22. It is noted that the motor stator 84, the lower jacket 20 and the upper jacket 19 remain rotationally stationary relative to the single steering shaft 22 during operation.

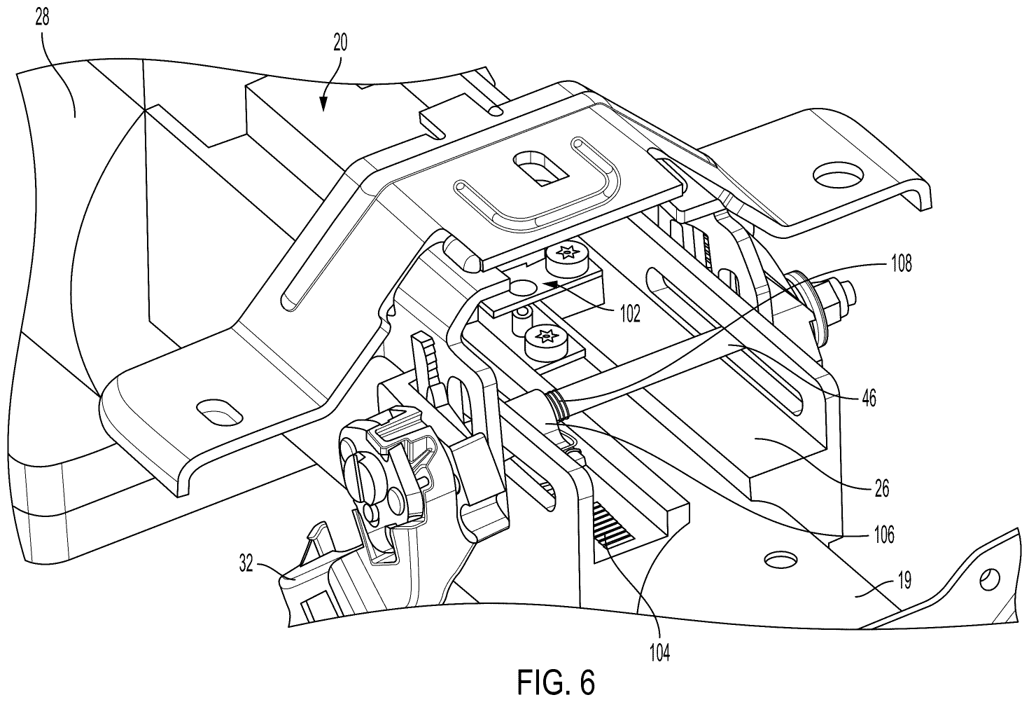

FIG. 2-6 illustrate an energy absorption assembly 100 for the steer-by-wire steering column assembly 10. The energy absorption assembly 100 includes an energy absorption strap 102 coupled to an outer surface of the lower jacket 20 and having a plurality of teeth 104. The energy absorption assembly 100 also includes a pivotable member 106 having one or more teeth engageable with the teeth 104 of the energy absorption strap 102 to move the energy absorption assembly 100 between an engaged and disengaged condition by selectively moving the at least one tooth of the pivotable member 106 into and out of engagement with the plurality of teeth 104 of the energy absorption strap 102. The pivotable member 106 is pivoted in response to movement of the manual adjustment lever 32. During axial and/or rake adjustment of the steer-by-wire steering column assembly 10, the energy absorption assembly 100 is in the disengaged condition, but when the manual adjustment assembly 30 is locked, the energy absorption assembly 100 is engaged and prepared for energy absorption.

The energy absorption assembly 100 includes a biasing member 108, such as a spring, connected to the adjustment post 46 of the manual adjustment assembly 30. The biasing member 108 is also connected to the pivotable member 106 of the energy absorption assembly 100. The biasing member 108 biases the pivotable member 106 towards the engaged condition, such that its teeth are engaged with the teeth 104 of the energy absorption strap 102. However, rotation of the adjustment post 46 with the adjustment lever 32 overcomes the biasing force of the biasing member 108 to pivot the pivotable member 106 to the disengaged condition.

The embodiments disclosed herein provide a steer-by-wire steering column having a simplified design in terms of the number of components and integrates the actuator and actuator housing with the steering column.

While the invention has been described in detail in connection with only a limited number of embodiments, it is to be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Moreover, any feature, element, component or advantage of any one embodiment can be used on any of the other embodiments. Accordingly, the invention is not to be seen as limited by the foregoing description.

What is claimed is:

1. A steer-by-wire steering column comprising:
an upper jacket extending in a longitudinal direction;
a lower jacket extending in the longitudinal direction, the upper jacket in telescoping engagement with the lower jacket; and
a single steering shaft extending in the longitudinal direction and housed at least partially within the upper jacket and the lower jacket.

2. The steer-by-wire steering column of claim 1, further comprising a steer-by-wire electric actuator at least partially disposed within the lower jacket and surrounding the single steering shaft to provide resistance to the single steering shaft.

3. The steer-by-wire steering column of claim 1, further comprising a housing end structure operatively coupled to an open end of the lower jacket.

4. The steer-by-wire steering column of claim 2, wherein the lower jacket comprises a first portion and a second portion, the first portion housing at least a portion of the upper jacket, the second portion housing at least a portion of the electric actuator.

5. The steer-by-wire steering column of claim 4, wherein the first portion of the lower jacket defines a pair of slots for receiving an adjustment post of a manual adjustment assembly therethrough.

6. The steer-by-wire steering column of claim 4, wherein the second portion of the lower jacket defines a pair of slots for receiving components extending from a pivot post that the lower jacket moves relative to.

7. The steer-by-wire steering column of claim 6, wherein the pivot post is a mounting bracket.

8. The steer-by-wire steering column of claim 4, wherein the second portion of the lower jacket has a larger diameter than the first portion of the lower jacket.

9. The steer-by-wire steering column of claim 1, further comprising an energy absorption assembly operatively coupled to at least one of the lower jacket and the upper jacket.

10. The steer-by-wire steering column of claim 3, further comprising a rotation position sensor disposed within the housing end structure, wherein the rotation position sensor detects an angular rotational position of the single steering shaft.

11. The steer-by-wire steering column of claim 4, further comprising a rotation position sensor disposed within one of the lower jacket and the upper jacket, wherein the rotation position sensor detects an angular rotational position of the single steering shaft.

12. The steer-by-wire steering column of claim 3, further comprising a travel stop limiter disposed within the housing end structure to define a rotational limit in at least one direction for the single steering shaft.

13. The steer-by-wire steering column of claim 3, further comprising a travel stop limiter disposed within one of the lower jacket and the upper jacket to define a rotational limit in at least one direction for the single steering shaft.

14. A steer-by-wire steering column comprising:
an upper jacket extending in a longitudinal direction;
a lower jacket extending in the longitudinal direction, the upper jacket in telescoping engagement with the lower jacket, wherein the lower jacket comprises a first portion and a second portion;
a single steering shaft extending in the longitudinal direction and housed at least partially within the upper jacket and the lower jacket;
a steer-by-wire electric actuator at least partially disposed within the lower jacket and surrounding the single steering shaft to provide resistance to the single steering shaft, wherein the first portion houses at least a portion of the upper jacket and the second portion houses at least a portion of the electric actuator,
wherein the first portion of the lower jacket defines a pair of slots for receiving an adjustment post of a manual adjustment assembly therethrough,
wherein the second portion of the lower jacket defines a pair of slots for receiving components extending from a pivot post that the lower jacket moves relative to.

15. The steer-by-wire steering column of claim 14, further comprising a housing end structure operatively coupled to an open end of the lower jacket.

16. The steer-by-wire steering column of claim 15, further comprising a rotation position sensor disposed within the housing end structure, wherein the rotation position sensor detects an angular rotational position of the single steering shaft.

17. The steer-by-wire steering column of claim 14, further comprising a rotation position sensor disposed within one of the lower jacket and the upper jacket, wherein the rotation position sensor detects an angular rotational position of the single steering shaft.

18. The steer-by-wire steering column of claim 15, further comprising a travel stop limiter disposed within the housing end structure to define a rotational limit in at least one direction for the single steering shaft.

19. The steer-by-wire steering column of claim 14, further comprising a travel stop limiter disposed within one of the lower jacket and the upper jacket to define a rotational limit in at least one direction for the single steering shaft.
